(19) United States
(12) Patent Application Publication
(10) Pub. No.: US 2023/0090882 A1
(43) Pub. Date: Mar. 23, 2023

(54) ADJUSTABLE WEIGHT DISTRIBUTION FOR PROTECTIVE SUITS

(71) Applicant: Atlas Devices LLC, Chelmsford, MA (US)

(72) Inventors: Nathan Ball, Forest Grove, OR (US); Daniel Walker, Melrose, MA (US)

(21) Appl. No.: 17/951,044

(22) Filed: Sep. 22, 2022

Related U.S. Application Data
(60) Provisional application No. 63/360,328, filed on Sep. 22, 2021.

(51) Int. Cl. B64G 6/00

(52) U.S. Cl. CPC B64G 6/00

(57) ABSTRACT

A weight distribution system for a protective suit includes a harness. The harness has a harness interface. The system also has a suit interface coupled to the protective suit. The system further includes a strap adjuster which adjusts the length of a strap between the harness interface and the suit interface in response to a user input. The system further includes an input device that receives the user input from a user.

### PRIORITY

This patent application claims priority from provisional U.S. patent application No. 63/360,328, filed Sep. 22, 2021, entitled, “SPACE SUIT SUSPENSION SYSTEM,” and naming Nathan Ball and Daniel Walker as inventors, the disclosure of which is incorporated herein, in its entirety, by reference.

### FIELD

Illustrative embodiments of the invention generally relate to protective suits and, more particularly, various embodiments of the invention relate to a adjusting weight distribution for the protective suit while wearing the protective suit.

### BACKGROUND

Protective suits, such as space suits, are designed to protect a wearer in a hostile environment. To adequately protect a wearer, some protective suits may have considerable weight. For example, a space suit may weight 400 lbs. on Earth. In microgravity environments, the weight of a space suit exerts little load on the astronaut's body and can be repositioned with relative ease. By contrast, the weight of a space suit on extraterrestrial missions, such as missions to the Moon, Mars and beyond, is borne by the astronaut's body. The weight of the space suit may be physically taxing and may interfere with proper adjustment of wearer's position with the space suit. Undesirably, space suits may cause issues such as A) shoulder fatigue, B) back fatigue, C) shoulder discomfort, D) friction discomfort, and E) problems with range of motion resulting from the suit's joint axes and locations being improperly aligned with the wearer's joints. Additionally, when an astronaut is supported by the protective suit, such as while sitting on a seat in a vehicle or while suspended from a rope while rappelling, the astronaut may slide down too low in the suit, resulting in restricted mobility and impaired visual awareness.

### SUMMARY OF VARIOUS EMBODIMENTS

In accordance with one embodiment of the invention, a weight distribution system for a protective suit has a harness having a harness interface and a suit interface to be coupled to the protective suit. The weight distribution system has a strap adjuster which adjusts a length of a strap between the harness interface and the suit interface in response to a user input. The weight distribution system also has an input device to receive the user input. The input device may be located on an exterior surface of the protective suit.

The strap adjuster may include a motor and a reel configured to grip the strap. Alternatively, the strap adjuster may include a reel and the user input is a rotational force. The input device transfers the rotational force to the reel.

In some embodiments, the weight distribution system includes another suit interface and another harness interface. The strap adjuster adjusts a second length of the strap between the second suit interface and the second harness interface while adjusting the first length of the strap between the first harness interface and the first suit interface in response to the user input.

In some embodiments, the strap adjuster has a pulley to grip the strap between the first length and the second length, and the input device either transfers rotational force to the pulley or operates a motor to exert rotational force on the pulley. The strap adjuster may shorten the first length while lengthening the second length and lengthen the first length while shortening the second length. Each of the strap ends may be coupled to harness interfaces.

In some embodiments, the strap adjuster includes a ratchet.

Illustrative embodiments are implemented as a method for adjusting a protective suit including 1) providing a harness coupled to an interior surface of the protective suit by a strap; 2) providing a strap adjuster configured to adjust a strap length of the strap; 3) providing an input device located on an exterior surface of the protective suit; 4) receiving a user input from the input device; and 5) operating the strap adjuster to shorten or lengthen the strap length in response to receiving the user input.

The user input may be generated by a wearer sealed inside the protective suit, and the user input may be received by the user device at an exterior surface of the protective suit.

Operating the strap adjuster includes rotating a reel with a motor, the reel being configured to grip the strap. In some embodiments, the method resists a rotational force exerted on the reel from the strap using a ratchet.

In some embodiments, the strap adjuster includes a reel wherein the user input is a rotational force, and wherein receiving the user input from the input device includes transferring a rotational force from the input device to the reel.

Operating the strap adjuster to shorten a second strap length of the strap may occur while lengthening the first strap length in response to receiving the user input. Similarly, operating the strap adjuster to lengthen a second strap length of the strap may occur while shortening the first strap length in response to receiving the user input.

The strap adjuster includes a pulley configured to grip the strap between the first strap length and the second strap length, and wherein the input device is either configured to provide rotational force to the pulley, or configured to control a motor to exert rotational force on the pulley. The first strap end of the strap may be coupled to a first harness interface and a second strap end of the strap may be coupled to a second harness interface.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically shows a protective suit in a standing position in accordance with various embodiments.

FIG. 1B schematically shows a protective suit in a suspended position in accordance with various embodiments.

FIG. 2A schematically shows a weight distribution system for a protective suit using a strap adjuster for each adjustable strap length in accordance with various embodiments.

FIG. 2B schematically shows a weight distribution system for a protective suit using a strap adjuster for pairs of adjustable strap lengths in accordance with various embodiments.

FIGS. 3A-3E schematically show strap adjusters in accordance with various embodiments.

FIG. 4 shows a process for adjusting the weight distribution of a protective suit.

### DESCRIPTION OF ILLUSTRATIVE EMBODIMENTS

In illustrative embodiments, a weight distribution system is configured to distribute the weight of a protective suit carried by a wearer between the shoulders and hips of the wearer. By shifting the burden of the protective suit to the hips from the shoulders, the wearer is able to more comfortably bear the weight of the protective suit. The weight distribution system also distributes the weight of the wearer while the protective suit is suspended, or resting on a surface, and allows the wearer to remain properly aligned with the joints of the protective suit. The protective suit may be positioned upward and downward in relation to the wearer's body to adjust the suit's joint alignment with the wearer's own joints.

Within the protective suit, straps connecting a harness to the protective suit may be lengthened or shortened to distribute weight. The orientation of the body within the suit may also be adjusted by shortening or lengthening the straps to tune the protective suit alignment relative to the body of the wearer to maximize the wearer's mobility.

The strap adjustment may be controlled by a user, such as the wearer, using an input device located outside the protective suit. Among other things, the input device may be coupled to the exterior of the protective suit. The input device may generate a signal the operates a motor to adjust strap length(s) within the protective suit, or the input device may transfer a rotational force to a strap adjuster. Since the strap adjustment can be controlled externally, entering and exiting the protective suit becomes substantially easier. Details of illustrative embodiments are discussed below.

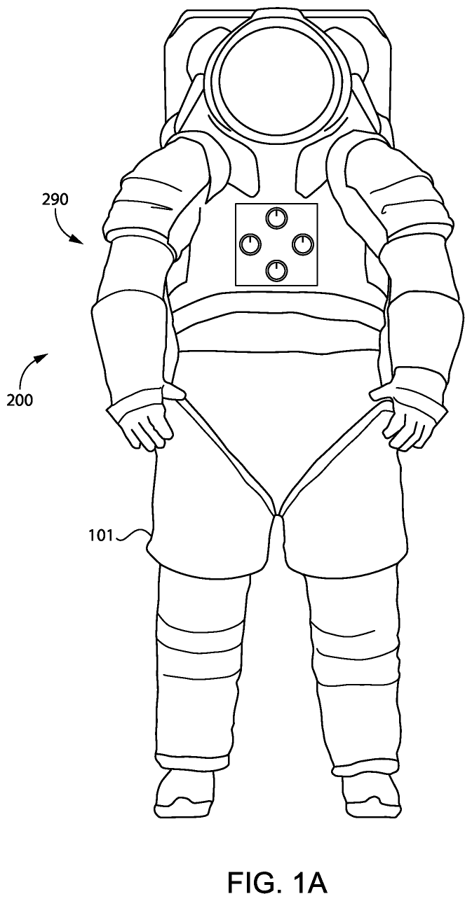

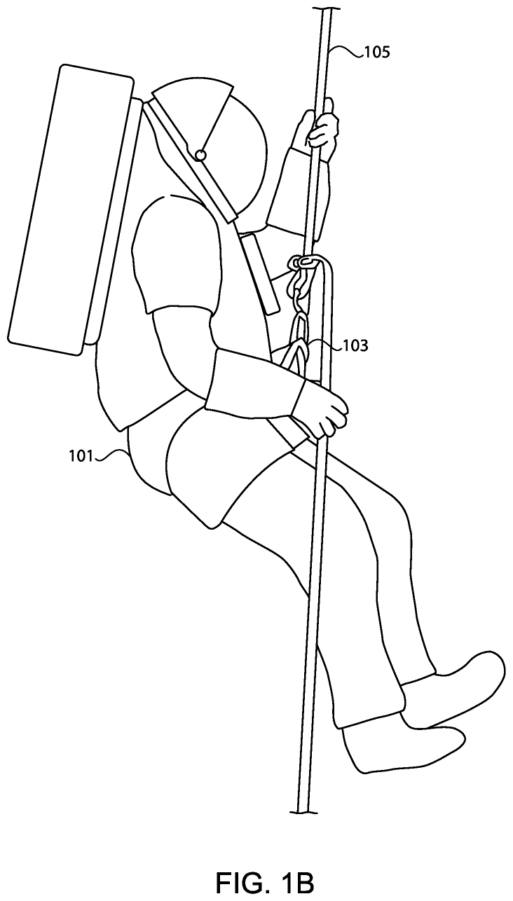

FIG. 1A schematically shows a protective suit 101 in a standing position in accordance with various embodiments. The protective suit 101 is configured to protect the wearer, who is housed within the protective suit 101, from the surrounding environment. In the illustrative embodiment, the protective suit 101 is a space suit configured to protect an astronaut. Among other things the protective suit 101 may be a diving suit, a fire proximity suit, an explosive ordnance disposal suit, a nuclear hazard suit, an exoskeleton, or a medical protective suit.

The protective suit 101 includes a weight distribution system 200 configured to adjustably distribute the weight of the astronaut and the protective suit 101. In a standing position, the astronaut bears the load of the protective suit 101, and the weight distribution system 200 may distribute the weight of the protective suit 101 between the hips and shoulders of the astronaut.

The weight distribution system 200 includes a control interface 290 configured to receive input from the astronaut to adjust the weight distribution. In the illustrated embodiment, the control interface 290 is located on the exterior surface of the protective suit 101, on the front of the protective suit 101 between the hip region and the shoulder region. The control interface 290 may instead be located anywhere on the exterior surface reachable by the astronaut while the astronaut is in the protective suit 101, or the control interface 290 may be a handheld device or other device separable or separated from the protective suit 101 but configured to communicate with the rest of the weight distribution system 200.

FIG. 1B schematically shows the protective suit 101 in a suspended position in accordance with various embodiments. The protective suit 101 is attached to a strap 105 at a connection point 103 on the exterior surface of the protective suit 101. While suspended, the weight distribution of the astronaut and the protective suit 101 changes relative to the weight distribution in the standing position illustrated in FIG. 1A. In the suspended position, the weight of the protective suit 101 is borne by the strap 105 and the protective suit 101 now bears the weight of the astronaut. Without the weight distribution system 200, the wearer would sink down into the protective suit 101, misaligning the suit joints and visor relative to the astronaut, which in turn limits the mobility and visual perception of the astronaut.

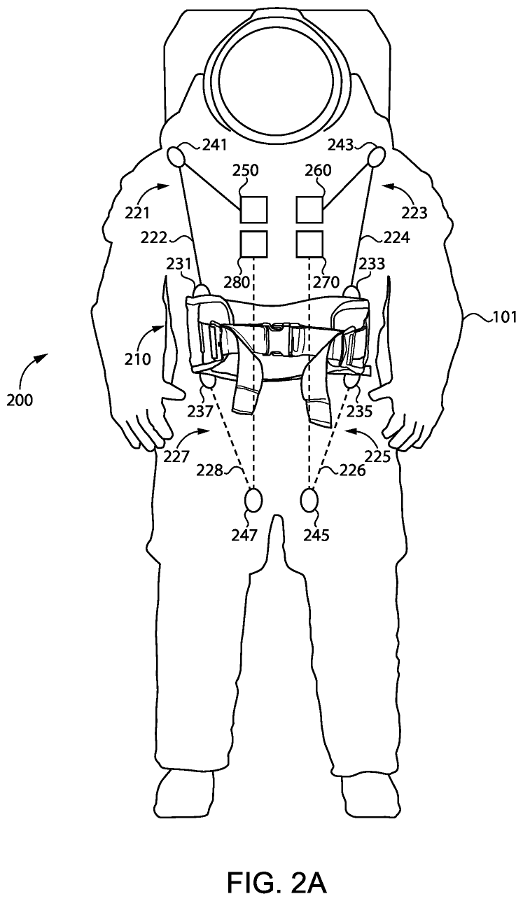

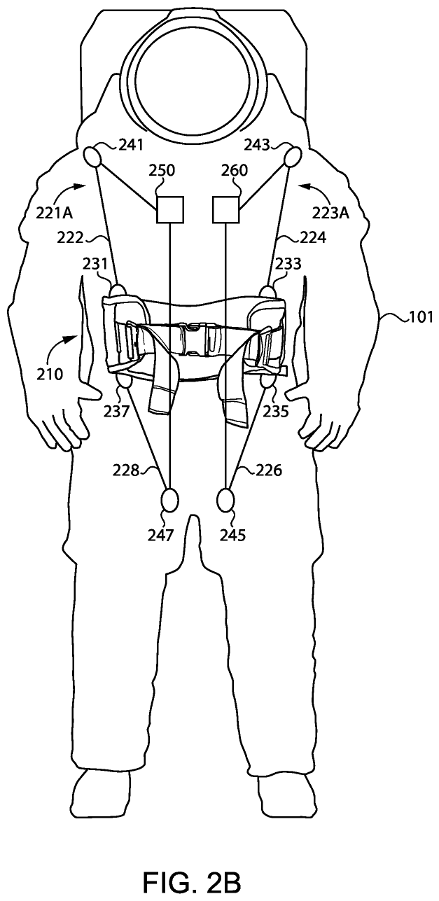

FIG. 2A is a cutaway view of the protective suit 101 schematically showing the weight distribution system 200 configured to distribute weight between the wearer inside the protective suit 101 and the protective suit 101 itself.

The weight distribution system has a harness 210 configured to tighten around the wearer to secure the wearer to the weight distribution system 200. In the illustrated embodiment, the harness 210 includes a hip belt configured to be positioned around the hips of the wearer. In some embodiments, the harness 210 has leg loops in addition to the hip belt, such as a climbing harness, among other things.

The harness 210 includes harness interfaces 231, 233, 235, and 238, each configured to couple to a respective strap. Coupling to a strap may include attaching the harness interface to an end of the strap, attaching an end of the strap to the harness interface, or routing the strap through the harness interface, depending on the strap configuration. In the illustrated embodiments, the harness interface 231 is attached to an end of an upper strap 221; the harness interface 233 is attached to an end of an upper strap 223; the harness interface 235 is attached to an end of a lower strap 225; and the harness interface 237 is attached to an end of a lower strap 227. A strap may be coupled to more than one harness interface. Each harness interface may include a loop, D-ring, pulley, or carabiner, among other things.

In some embodiments, the couplings between the harness interfaces of the harness 210 and the upper straps 221 and 223, and the lower straps 225 and 227 may be configured so the harness 210 may be put on by the wearer of the protective suit 101 before entering the protective suit 101.

The weight distribution system 200 includes suit interfaces 241, 243, 245, and 247, each configured to couple to a respective strap. Coupling to a strap may include attaching the suit interface to an end of the strap, attaching an end of the strap to the suit interface, or routing the strap through the suit interface, depending on the strap configuration. In the illustrated embodiment, strap 221 is routed through suit interface 241; strap 223 is routed through suit interface 243; strap 225 is routed through suit interface 245; and strap 227 is routed through suit interface 247. A strap may be coupled to more than one suit interface. For example, the strap may be routed through multiple suit interfaces. Each suit interface may include a loop, D-ring, pulley, or carabiner, among other things.

The position of each suit interface is configured to direct a force generated by a strap adjuster. The illustrated positions of the suit interfaces 241, 243, 245, and 247 are but one example. The suit interfaces 245 and 247 may be positioned anywhere below the harness 210 so that a tightening of straps 225 and 227, respectively, lowers the harness 210. Similarly, the suit interfaces 241 and 243 may be positioned anywhere above the harness 210 so that a tightening of straps 221 and 223, respectively, raises the harness 210.

In the illustrated embodiments, one end of each strap is attached to a harness interface and the strap is routed through a corresponding suit interface. In some embodiments, one end of each strap is attached to a suit interface and routed through a corresponding harness interface. In some embodiments, one strap end may be attached to a harness interface and the other end may be attached to a suit interface.

The straps 221, 223, 225, and 227 may be strip-like elongate tensile members, webbing, belt, cable, rope, other cordage, or another type of member having an elongate shape. Each strap includes a length between a harness interface and a suit interface. For example, the strap 221 includes a length 222 between the harness interface 231 and the suit interface 241; the strap 223 includes a length 224 between the harness interface 233 and the suit interface 243; the strap 227 includes a length 228 between the harness interface 237 and the suit interface 247; and the strap 225 includes a length 226 between the harness interface 235 and suit interface 245.

The weight distribution system 200 includes four strap adjusters 250, 260, 270, and 280, each configured to adjust a length of straps 221, 223, 225, and 227, respectively, and by extension the lengths 222, 224, 226, and 228, respectively. In the illustrated embodiment, the strap adjusters 250, 260, 270, and 280 are positioned above the harness 210 between the wearer's hips and shoulder, but the strap adjusters may be located elsewhere within the protective suit 101. For example, one or more strap adjusters may be placed near a suit interface or near a harness interface. In some embodiments, a strap adjuster may be placed such that a strap is not required to be routed through a suit interface or a harness interface.

By tightening upper straps 221 and 223, and loosening lower straps 225 and 227, the strap adjusters 250, 260, 270 and 280 raise the harness 210. Where the protective suit 101 is suspended or sitting on a surface, the wearer may raise the harness 210 to elevate the wearer into alignment with the joints of the protective suit 101. By loosening upper straps 221 and 223, and tightening lower straps 225 and 227, the burden of carrying the protective suit 101 is shifted from the shoulders of the wearer to the hips while in the standing position.

In some embodiments, the weight distribution system 200 includes a strap adjuster, strap, and harness interface configured to adjust one part of the harness 210 in order to adjust an angle of the wearer relative to the protective suit. For example, raising the harness 210 behind the wearer may angle the wearer forward in the protective suit 101. In some embodiments, the weight distribution system 200 may include components such as a strap adjuster strap, and harness interfaces collectively configured to tighten or loosen a hip belt of the harness 210. In some embodiments, the protective suit includes adjustable padded shoulder straps that may be adjusted by the weight distribution system 200 using a strap adjuster.

It should be appreciated that the features of the weight distribution system 200 may be included in other illustrated embodiments of the weight distribution system 200 described herein.

FIG. 2B schematically shows the weight distribution system 200 for protective suit 101 having two strap adjusters 250 and 260, rather than the four strap adjusters illustrated in FIG. 2A. The strap adjuster 250 is configured to adjust the strap 221A, and by extension, simultaneously adjust lengths 222 and 228. The strap 221A has a strap end coupled to the harness interface 231 and another strap end coupled to the harness interface 237. Between the harness interfaces 231 and 237, strap 221A is routed through the suit interface 241, the strap adjuster 250, and the suit interface 247. To raise the right side of the harness 210, the strap adjuster 250 moves the strap 221A towards the harness interface 237, thereby lengthening length 228 and shortening length 222. To lower the right side of the harness 210, the strap adjuster 250 moves the strap 221A towards harness interface 231, thereby lengthening the length 222 and shortening the length 228.

The strap adjuster 260 is configured to adjust the strap 223A, and by extension, simultaneously adjust the lengths 224 and 226. The strap 223A has a strap end coupled to the harness interface 233 and another strap end coupled to the harness interface 235. Between the harness interfaces 233 and 235, strap 223A is routed through the suit interface 243, the strap adjuster 260, and the suit interface 245. To raise the left side of the harness 210, the strap adjuster 260 moves the strap 223A towards the harness interface 235, thereby lengthening length 226 and shortening length 224. To lower the left side of the harness 210, the strap adjuster 260 moves the strap 223A towards harness interface 233, thereby lengthening length 224 and shortening length 226.

It should be appreciated that the illustrated embodiments only illustrate a portion of the components that may be included in the protective suit 101 and the weight distribution system 200, and only illustrate a portion of the arrangements for the weight distribution system. The protective suit 101 and the weight distribution system 200 may include a number of components or arrangements not illustrated or explicitly described herein.

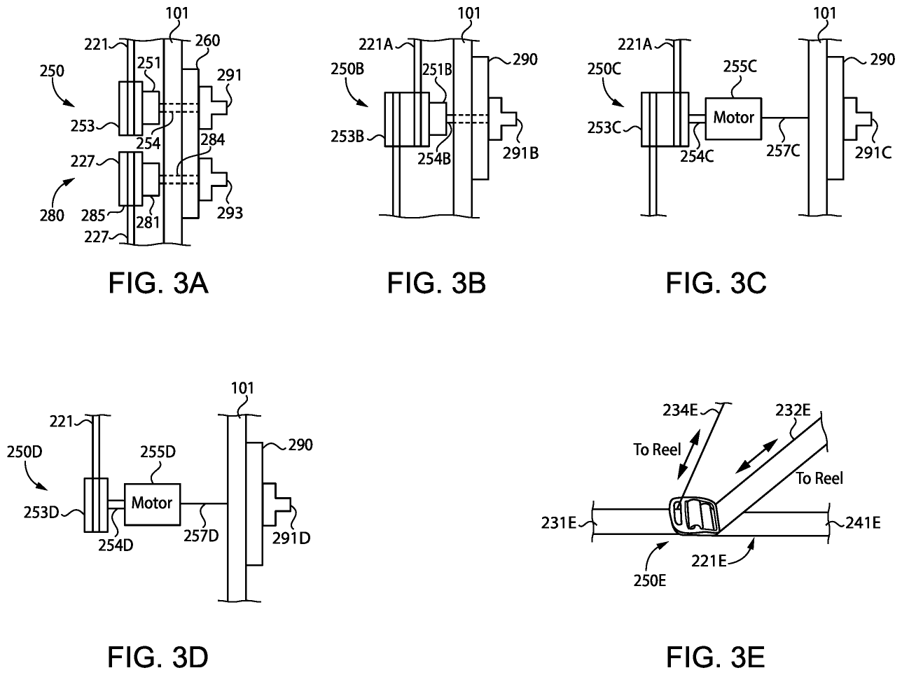

FIG. 3A schematically shows a strap adjuster arrangement configured to separately adjust the upper strap 221 and the lower strap 227 in accordance with various embodiments.

The strap adjuster 250 is configured to shorten and lengthen the length 222 of strap 221 by winding and unwinding strap 221. The strap adjuster 250 includes a reel 253 configured to grip the strap 221 and wind/unwind the strap 221 while rotating about an axis. A strap end of the strap 221 may be coupled to the reel 253. The reel may include additional components to enhance friction or lock the strap 221 in place, such as V-grooves or teeth configured to engage the strap 221.

The strap adjuster 250 also includes a shaft 254 configured to receive a rotational force from the control interface 290 and transfer the rotational force to the reel 253 by way of a ratchet 251. The shaft is coupled to the control interface 290 and the ratchet by way of an opening in the protective suit 101.

The ratchet 251 is configured to allow rotational force transmitted by the shaft 254 from an to spin the reel 253 and lock to prevent rotational force exerted by the strap 221 from unwinding the strap by rotating the reel 253. In some embodiments, the ratchet may include a clutch bearing or another type of locking mechanism configured to spin freely while rotating in one direction while resisting rotation in the opposite direction. In some embodiments, the ratchet 251 may include a releasable progress capture mechanism such as a Weston style brake, which locks against tension as a ratchet does, but releases the tension in a controlled manner as shaft 254 is turned in the opposite direction

The control interface 290 has an input device 291 configured to receive a rotational force from a user, such as the wearer. In the illustrated embodiment, the input device 291 may include a dial or another type of device configured to receive rotational force. The input device 291 may be rotated in a clockwise direction and a counterclockwise direction. When rotated in a first direction, the generated rotational force causes the reel 253 to wind the strap 221, thereby shortening the strap length 222 and raising the harness 210. When rotated in the opposite direction, the generated rotational force releases the ratchet, causing the reel 253 to unwind the strap 221, thereby lengthening the strap length 222 and lowering the harness 210. When the user ceases to apply rotational force to the input device 291, the ratchet 251 is configured to lock, preventing further lengthening of the strap length 222.

The strap adjuster arrangement also includes the strap adjuster 280. It should be appreciated that features described with respect to the components of the strap adjuster 250 may also be present in the components of other strap adjusters, such as the strap adjuster 280. The strap adjuster 280 is configured to shorten and lengthen the length 228 of strap 227 by winding and unwinding strap 227. The strap adjuster 250 includes a reel 283 configured to grip the strap 227 and wind/unwind the strap 227 while rotating about an axis. A strap end of strap 227 may be coupled to the reel 253. Similar to the strap adjuster 250, the strap adjuster 280 also includes a shaft 284 and a ratchet 281.

The control interface 290 includes an input device 293 coupled to shaft 284 and configured to receive a rotational force from a user and exert the rotational force on the shaft 284.

FIG. 3B schematically shows a strap adjuster 250B configured to adjust a combined strap 221A in accordance with various embodiments. The strap adjuster 250B is configured to receive a rotational force from the input device 291B and lengthen or shorten lengths 222 and 228 of strap 221A in response to the rotational force.

The strap adjuster 250B includes a pulley 253B configured to grip the strap 221A with sufficient force to prevent slippage while the pulley 253B is not receiving a rotational force from a shaft 254B and while the pulley 253B is receiving a rotational force from the shaft 254B. The pulley 253B may include additional components to enhance friction or lock the strap 221A in place, such as V-grooves or teeth configured to engage the strap 221A. In some embodiments, the strap 221A is wound around the pulley multiple times to increase the friction between the strap 221A and the pulley 253B, thereby preventing slippage.

The strap adjuster 250B has a ratchet 251B configured to prevent rotation of the pulley 253B due to a rotational force exerted on the pulley 253B by the strap 221A, while allowing rotation of the pulley 253B due to a rotational force exerted on the pulley 253B from user device 291B.

The control interface 290 includes the user device 291B configured to receive a rotational force in a clockwise direction and a counterclockwise direction. The rotational force received by the user device 291B and transferred to pulley 253B by ratchet 251B and shaft 254B, causes the rotation of the pulley 253B, which simultaneously adjusts the lengths 222 and 228 of the strap 221A. For example, when the user device 291B is rotated in a clockwise direction, the portion of the strap 221A above the pulley 253B may lengthen, thereby lengthening length 222 of the strap 221A, while the portion of the strap 221A below the pulley 253B may shorten, thereby shortening length 228 of the strap 221A.

FIG. 3C schematically shows a strap adjuster 250C configured to adjust the combined strap 221A in accordance with various embodiments. The strap adjuster 250C is configured to receive a signal from the input device 291C and lengthen or shorten lengths 222 and 228 of strap 221A in response to the signal. The input device 291C may include a switch, a selector, or another device configured to transmit a signal. The input device 291C may include further circuitry to process user input into a signal to be transmitted to the strap adjuster 250C, such as analog or digital circuitry. The signal transmitted to the strap adjuster may include a power signal or a command signal.

The strap adjuster 250C includes a pulley 253C having the features described with respect to pulley 253B. In contrast to the strap adjuster 250, the strap adjuster 250C includes an electric motor 255C configured to provide a rotational force to the pulley 253C by way of a shaft 254C in response to the signal received from the input device 291C by way of signal channel 257C, which may be a wired or wireless channel. For example, the motor 255C may receive a power signal, causing the motor to rotate, or the motor 255C may receive a command signal including instructions for rotating the motor 255C to be interpreted and executed by the motor 255C. In some embodiments, the motor 255C includes a gearbox configured to adjust an angular speed of the shaft 254C. It should be appreciated that the features of the strap adjuster 250C may also be present other strap adjusters, such as the strap adjuster 250D in FIG. 3D.

FIG. 3D schematically shows a strap adjuster 250D configured to adjust the upper strap 221 in accordance with various embodiments. The strap adjuster 250D is configured to receive a signal from the input device 291D and lengthen or shorten length 222 of strap 221 in response to the signal. The strap adjuster 250D has a motor configured to receive a signal from the input device 291D by way of signal channel 257D and exert a rotational force on a pulley 253D by way of shaft 254D in response to receiving the signal.

FIG. 3E schematically shows a strap adjuster 250E configured to adjust the length of the aggregated strap 221E/222 formed from two strap portions joined at the strap adjuster 250E between the harness interface 231E and the suit interface 241. The strap adjuster 250E is a self-locking device whose tightening adjustment is achieved by pulling on a loose end, tail 232E. In the illustrated embodiment, the strap adjuster 250E has a strap regulator configured to couple to one strap portion while holding another strap portion in place using friction. The strap adjuster 250E may also be another type of tightening/loosening device, such as a cam buckle or cinch buckle, among other things. To shorten the strap 221E/222, a reel, pulley, or other device may pull on the strap tail 232E. To lengthen the strap 221E/222, a reel, pulley, or other device may pull on strap 234E.

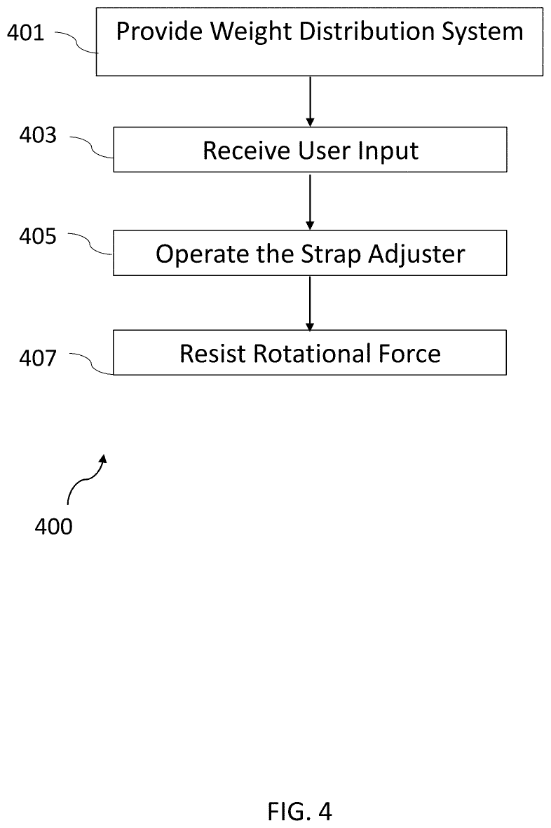

FIG. 4 shows a process 400 for adjusting the weight distribution system 200 for the protective suit 101 in accordance with various embodiments. While process 400 is described with respective to the embodiments illustrated in FIGS. 2 and 3A, Process 400 may be implemented using any of the illustrated embodiments disclosed herein. It should be appreciated that a number of variations and modifications to Process 400 are contemplated including, for example, the omission of one or more aspects of Process 400, the addition of further conditionals and operations, or the reorganization or separation of operations and conditionals into separate processes.

Process 400 begins at operation 401 including providing the harness 210, the strap adjuster 250 and the input device 291. The harness 210 is coupled to the interior surface of the protective suit 101 by the strap 221. The strap adjuster 250 adjusts the length of the strap. The input device 291 may be located outside the protective suit 101, such as on an exterior surface of the protective suit 101.

The input device 291 then receives a user input in operation 403. The user input may be a signal generated by a user operating the input device 291, or a rotational force exerted on the input device 291 by a user. The user may be the wearer of the protective suit 101 and the user input may be received from the wearer while the protective suit 101 is closed and the wearer is sealed within the protective suit 101.

In response to receiving the user input, the strap adjuster 250 operates to shorten or lengthen strap length 222 in operation 405. Where the user input is a rotational force, operation 405 includes transferring the rotational force from the input device 291 to the reel 253 to cause the rotation of the reel 253. Where the user input is a signal, operation 405 includes controlling a motor to rotate a reel.

In some embodiments, operation 405 includes adjusting more than one strap length simultaneously using a pulley rotated by rotational force generated by a motor or the input device 291.

In some embodiments, such as the illustrated embodiments, where the strap adjuster 250 includes the ratchet 251, the ratchet 251 resists a rotational force exerted on the reel from the strap 221 by locking in operation 407.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A weight distribution system for a protective suit, comprising:
a harness including a harness interface;
a suit interface configured to be coupled to the protective suit;
a strap adjuster configured to adjust a length of a strap between the harness interface and the suit interface in response to a user input; and
an input device configured to receive the user input.

2. The weight distribution system of claim 1, wherein the input device is located on an exterior surface of the protective suit.

3. The weight distribution system of claim 1, wherein the strap adjuster includes a motor and a reel configured to grip the strap.

4. The weight distribution system of claim 1, wherein the strap adjuster includes a reel, wherein the user input is a rotational force, and wherein the input device is configured to transfer a rotational force to the reel.

5. The weight distribution system of claim 1, comprising:
a second suit interface and a second harness interface,
wherein the strap adjuster is configured to adjust a second length of the strap between the second suit interface and the second harness interface while adjusting the first length of the strap between the first harness interface and the first suit interface in response to the user input.

6. The weight distribution system of claim 5, wherein the strap adjuster includes a pulley configured to grip the strap between the first length and the second length, and wherein the input device is either configured to transfer rotational force to the pulley, or configured to operate a motor to exert rotational force on the pulley.

7. The weight distribution system of claim 5, wherein the strap adjuster is configured to shorten the first length while lengthening the second length, and lengthen the first length while shortening the second length.

8. The weight distribution system of claim 5, wherein the strap adjuster includes a ratchet.

9. The weight distribution system of claim 5, wherein a first strap end of the strap is coupled to the first harness interface and a second strap end of the strap is coupled to the second harness interface.

10. A method for adjusting a protective suit, comprising:
providing a harness coupled to an interior surface of the protective suit by a strap;
providing a strap adjuster configured to adjust a strap length of the strap;
providing an input device located on an exterior surface of the protective suit;
receiving a user input from the input device; and
operating the strap adjuster to shorten or lengthen the strap length in response to receiving the user input.

11. The method of claim 10, wherein receiving the user input is generated by a wearer sealed inside the protective suit.

12. The method of claim 10, wherein operating the strap adjuster includes rotating a reel with a motor, the reel being configured to grip the strap.

13. The method of claim 10, wherein the strap adjuster includes a reel, wherein the user input is a rotational force, and wherein receiving the user input from the input device includes transferring a rotational force from the input device to the reel.

14. The method of claim 13, comprising:
resisting a rotational force exerted on the reel from the strap using a ratchet.

15. The method of claim 10, comprising:
operating the strap adjuster to shorten a second strap length of the strap while lengthening the first strap length in response to receiving the user input.

16. The method of claim 15, wherein the strap adjuster includes a pulley configured to grip the strap between the first strap length and the second strap length, and wherein the input device is either configured to provide rotational force to the pulley, or configured to control a motor to exert rotational force on the pulley.

17. The method of claim 15, comprising:
operating the strap adjuster to lengthen a second strap length of the strap while shortening the first strap length in response to receiving the user input.

18. The method of claim 15, wherein a first strap end of the strap is coupled to a first harness interface and a second strap end of the strap is coupled to a second harness interface.

19. A weight distribution system for a protective suit, comprising:
a means for strapping a harness to an interior of the protective suit;
a means for receiving user input from outside of the protective suit while the protective suit is closed; and
a means for adjusting a vertical position of the harness relative to the protective suit in response to a user input.

20. The weight distribution system of claim 19, wherein the means for adjusting the vertical position of the harness includes a means for adjusting a strap length.
